(19) United States
(12) Patent Application Publication
(10) Pub. No.: US 2014/0214651 A1
(43) Pub. Date: Jul. 31, 2014

(54) METHODS AND SYSTEMS FOR LEAST-COST ROUTING OF TRANSACTIONS FOR MERCHANTS

(71) Applicant: MphasiS Limited, Bangalore (IN)

(72) Inventor: Chinni Krishna PRASADH, Chennai (IN)

(21) Appl. No.: 13/951,752

(22) Filed: Jul. 26, 2013

(30) Foreign Application Priority Data
Jan. 29, 2013 (IN) 429/CHE/2013
Jul. 10, 2013 (IN) 369/CHE/2013

(51) Int. Cl. G06Q 20/12

(52) U.S. Cl. CPC G06Q 20/12
USPC 705/39

(57) ABSTRACT

A computer-implemented method, executed by a hardware provider payment gateway system to select a least-cost payment acquirer for an electronic payment to a merchant, includes loading transaction and payment details of a payment instrument. An acquirer list of one or more payment acquirers associated with the merchant and available to the provider payment gateway system is retrieved. A least-cost acquirer among the one or more payment acquirers is determined, by the provider payment gateway system, utilizing a set of predetermined parameters.

### BACKGROUND

The payment processing industry is going through an upheaval. The advent of the Internet and high-speed mobile and telephony networks has resulted in merchants delivering content or service to the customer through various access channels. The customer of today needs multiple ways of connecting and transacting with a merchant for delivery of content or services. The exponential growth of commerce carried out in the Internet and mobile environments has changed the payment habits of the customer leading to the phenomenal growth of the payments industry. This has led to the emergence of a plethora of payment gateways looking to make the most of this promising line of business. The acquiring business environment has become highly competitive as many financial institutions actively seek ways to evolve and expand their merchant acquiring portfolio.

A merchant is an entity from whom goods or services are purchased either directly from store or from online portals. Where a payment card is used for such purchases, a payment gateway connects a merchant with a payment processor for facilitating the transfer of information between a payment portal (such as a website, mobile device or Interactive Voice Response (IVR) service) and the payment processor or payment card acquiring institution. The payment gateway ensures that information is passed securely between the merchant and the payment processor. A payment gateway collects the payment transaction information and routes the details to a payment card acquiring institution for authorization. The payment card acquiring institution checks whether the payment card utilized in the transaction has been issued by itself. If the payment card acquiring institution is also the payment card issuing institution then the transaction is processed in-house without the need to contact the payment card associations for routing the transaction to the payment card issuing institution. The payments industry parlance labels the transactions matching the above transaction example as an “On-Us” transaction. If the payment card utilized in the example payment transaction has been issued by any institution other than the payment card acquiring institution then the payment transaction is routed to the payment card issuing institution for authorization through the payment card associations. The payments industry parlance labels the transactions matching the above transaction example as an “Off-Us” transaction.

Interchange/Processing fees are paid to Payment Card issuing institutions and Payment Card associations for accepting and processing payment transactions from the Payment Card acquiring institutions. Interchange and processing fees are paid every time a cardholder makes a purchase using a payment card. The interchange fees levied for a merchant are influenced by various factors like the merchant category, payment card's brand, location or region, payment type (in-store, Online, mobile, IVR, card present, card not present), and the size, nature, volume of the merchant business.

A provider payment gateway offers merchants' online services for accepting electronic payments by a variety of payment methods including credit card, bank-based payments such as direct debit, bank transfer, and real-time bank transfer based on online banking. Provider payment gateways provide unique services to process other next generation methods (Payment systems) like PAYPAL™, GOOGLE CHECKOUT, etc. Typically, a provider payment gateway can connect to multiple acquiring banks, card, and payment networks. In many cases, the provider payment gateways will fully manage these technical connections, relationships with the external network, and bank accounts. This makes the merchants less dependent on financial institutions and free from the task of establishing these connections directly—especially when operating globally.

### BRIEF DESCRIPTION OF THE FIGURES

The present disclosure is illustrated by way of example and not limitation in the figures of the accompanying drawings, in which like references indicate similar elements and in which:

FIG. 1 is a high-level block diagram of a payment gateway in accordance with one or more embodiments.

FIG. 2 is a functional block diagram of a provider Payment Gateway system according to an embodiment.

FIG. 3 is a high-level block diagram of risk management in processing payments in accordance with one or more embodiments.

FIG. 4 is a high-level block diagram of risk management in processing payments according to another embodiment.

FIG. 5 is a functional block diagram of a least-cost routing software application and an overall provider payment gateway system according to an embodiment.

FIG. 6 is a flow chart of a method for determining a lowest cost for transaction processing according to an embodiment.

FIG. 7 is a graphical representation of the working flows of a predictive adaptive analyzer according to an embodiment.

FIG. 8 is a flow chart of a method of effecting automatic reconciliation of payment data according to an embodiment.

FIG. 9 is a graphical representation of various groups of rules for least-cost routing according to an embodiment.

### DETAILED DESCRIPTION

Various embodiments according to a method and a system to process transactions through a provider payment gateway are described in detail. The specific details of the present disclosure are explained in detail with the help of the various accompanying diagrams.

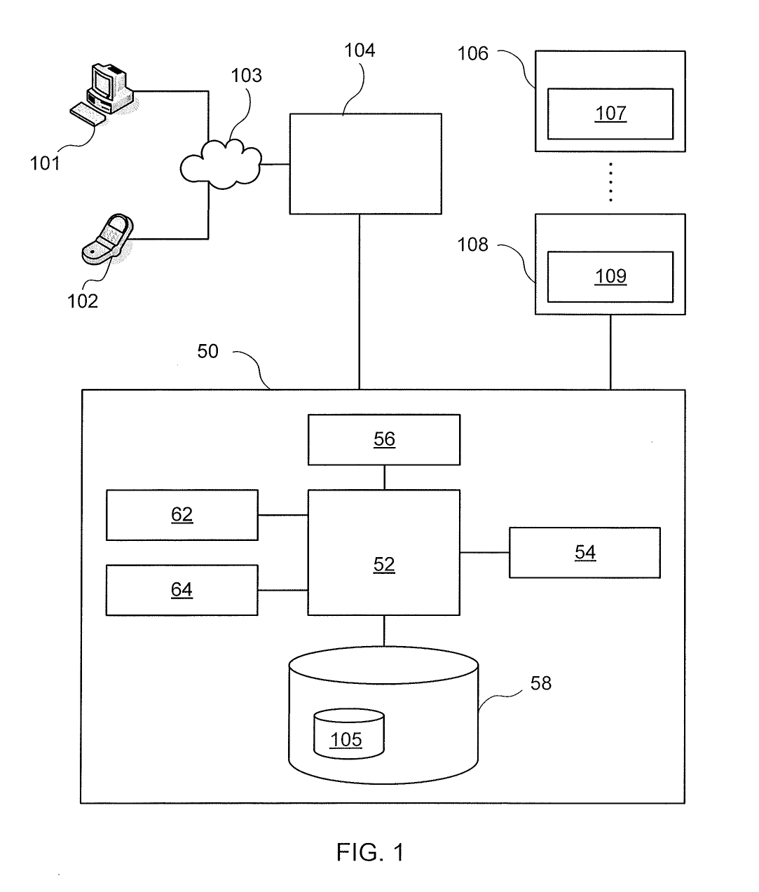

FIG. 1 is a diagrammatic representation of a provider payment gateway as part of a broader ecommerce system which can be accessed over the Internet, (via wired or wireless mechanisms). A provider payment gateway application 105 handles payments for all transactions carried out on the merchant's ecommerce application 104. The ecommerce transaction is established by the merchant entity by operating the merchant's ecommerce application 104 as part of sale of goods/services. The customer using a payment card is directed to interact with the provider payment gateway application 105 for payment towards goods or services listed on the merchant's ecommerce application 104. The provider payment gateway application 105 routes the payment transaction to a payment card acquiring device of one or more payment card acquiring institutions (also referred to as the “payment card acquiring institution 106 or 108” in this disclosure for simplifying the description) for securing authorization and processing of the payment transaction. The payment card acquiring institutions 106 and 108 have internal risk management applications 107 and 109 to check incoming transactions for fraudulent activity. The payment transaction is built based on a standard titled “ISO 8583” Financial transaction card message type and has three parts:
Part 1: Messages, data elements and code values;
Part 2: Application and registration procedures for Institution Identification Codes (IIC); and
Part 3: Maintenance procedures for messages, data elements and code values.

A person having ordinary skill in the art would appreciate that, throughout the present disclosure, description regarding actions and operations of applications or software applications refers to the actions and operations performed by corresponding one or more hardware processors executing the applications or software applications.

In operation, the merchants' ecommerce application 104 is accessed over the Internet 103 using a personal computer 101 or an Internet enabled mobile device 102. Contents or services listed according to the ecommerce application 104 are selectable by a customer operating the personal computer 101 or the Internet enabled mobile device 102. Once a selection is made, the customer is directed to make payment by presenting his/her payment card information. The merchant's ecommerce application 104 requests the provider payment gateway application 105 for authorization. The provider payment gateway routes the payment transaction details to the payment card acquiring institutions 106 or 108 for authorization. The payment card acquiring institutions 106 or 108 check the incoming transaction by executing risk management application 107 or 109 respectively before processing the transaction. The result of the transaction authorization request is communicated back to the provider payment gateway application 105 by the payment card acquiring institutions 106 or 108, and in turn the provider payment gateway application 105 communicates the results of the authorization request to the merchant's ecommerce application 104.

Based on the above process scenario, the relationship between the merchant, the provider payment gateway and the payment card acquiring institutions will now be described in detail to bring out the existing problems in the current scenario.

FIG. 1 also depicts a high level functional diagram of server/computer system 50 on which the Provider Payment gateway application 105 gets executed. Computer system comprises a processor 52, a memory 54, a network interface (I/F) 56, a storage device 58, an input device 62 and an output device 64.

Memory 56 may comprise of a random access memory (RAM) or other dynamic storage device. Memory also may be used for storing temporary variables or other intermediate information during execution of instructions to be executed by processor 52.

Network 56 comprises a mechanism for connecting to another device. In some embodiments, server/computer 50 comprises more than a single network interface. Storage device 58, comprises items such as read only memory (ROM), a magnetic disk or an optical disk for storing data related to authorized Payment transactions, Reconciled and settled transactions. I/O devices 62 and 64 may comprise an input device, an output device and/or a combined input/output device for enabling user interactions. An input device may comprise a keyboard, mouse, trackball, and/or cursor direction keys for communicating information and commands to processor 52. An output device may comprise a display, a printer, etc. for communicating information to user. Processor 52 executes a set of executable instructions contained within various applications such as Provider Payment gateway application 105, Merchant eCommerce application 104, Risk management applications 107/109, etc. In some embodiments, storage device 58 stores instructions that are referred to as Provider Payment gateway application 105, Merchant eCommerce application 104, and/or Risk management applications 107/109 in this disclosure.

The relationship between the merchant, the provider payment gateway and payment card acquiring institutions hinges on the fees that are deducted from the transacted amount. The amount of fees that is deducted from the merchant is fixed based on a variety of parameters. In some embodiments, to reduce the fees substantially, the transaction is routed to the most likely cost efficient payment processor.

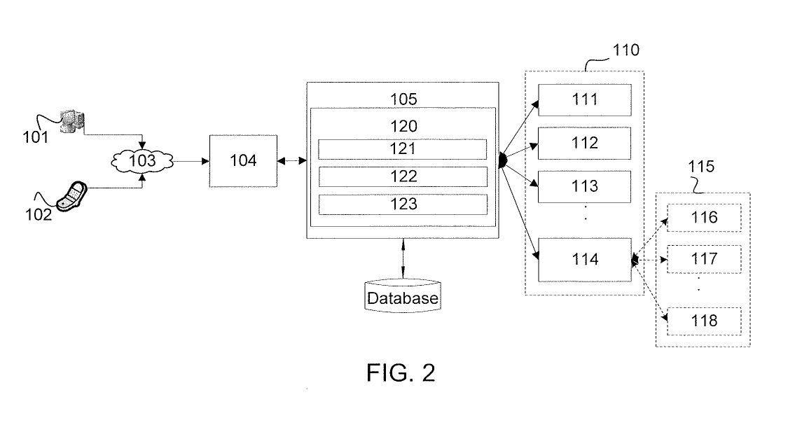

FIG. 2 is a diagrammatic representation of a provider payment gateway, according to an embodiment of the present disclosure. The provider payment gateway may conceptually be viewed as five different entities comprising a personal computer 101 or mobile or other handheld devices 102, merchant's ecommerce application 104 (when being executed by a corresponding processor), the provider payment gateway application 105, computer systems of multiple payment card issuing banks 115 (also simply referred to as “payment card issuing banks 115”), and computer systems of payment card acquiring banks 110 (also simply referred to as “payment card acquiring banks 110”) integrated with the present framework. Payment card issuing banks are not directly integrated with the provider payment gateway application 105 but routed through one of the acquiring banks integrated with the provider payment gateway application 105. There are multiple payment card issuing banks 116, 117, 118 contained within 115 and the appropriate payment card issuing bank will receive the payment transaction from least cost routing Payment card Acquirer 114 from the list of Payment card Acquirers 111, 112, 113 and 114.

A personal computer 101 and mobile or other handheld devices 102 are connected to the merchant's ecommerce application 104 through the Internet 103 allowing the consumers of the merchant's ecommerce application to shop for contents from the merchant's store at the consumer's own convenience. The provider payment gateway application 105 is equipped to respond to payment transaction processing requests received from consumers through the merchant's ecommerce system 104. The provider payment gateway application 105 comprises transaction processing application 120, risk management application 121, least-cost routing application 122 and a reconciliation application 123. Each of the above mentioned applications contain sets of instructions executable by one or more corresponding processors. Typically, the request received by the provider payment gateway 105 is processed by performing validations and verification procedures. These applications have been developed using Microsoft .NET framework and databases. In some embodiments, all the payment transactions are transmitted over secure HTTPS protocol. In some embodiments, the Business rules are built into these applications using other technologies like Java, Oracle/SQL Server.

In some embodiments, the risk management application 121 is integrated within the provider payment gateway application 105. In some embodiments, the risk management application 121 is effectively another system to analyze the risk profile of the transaction prior to sending it to the acquiring banks. The risk measured in the application by way of a risk score is the determining factor for routing the transaction to the payment card acquiring or payment card issuing banks represented by integrated payment card acquirers 111, 112, 113 and 114. The transaction is sent to the least-cost routing application 122 if the risk score is zero or lower than a threshold defined by the merchant, where in at least one embodiment the threshold is zero. Risk score is a score used to determine whether to authorize or reject a payment transaction. The score is assigned to the transaction based on various checks and validations. In at least some embodiments, risk score is determined based on parameters such as maximum transaction limit per day, number of transactions per day, place of usage, value of transactions, merchant category, number of rejections allowed in a day, etc. For example, if a stolen payment card is used for purchase of goods or services on merchant eCommerce application 104, the Risk management application 107/109 sends a high risk score and rejects the payment transaction. If a payment card issued by Payment card Issuing bank in India is used in a different country, then risk score is medium and the payment card issuing & acquiring bank will determine if this payment transaction can be approved or rejected.

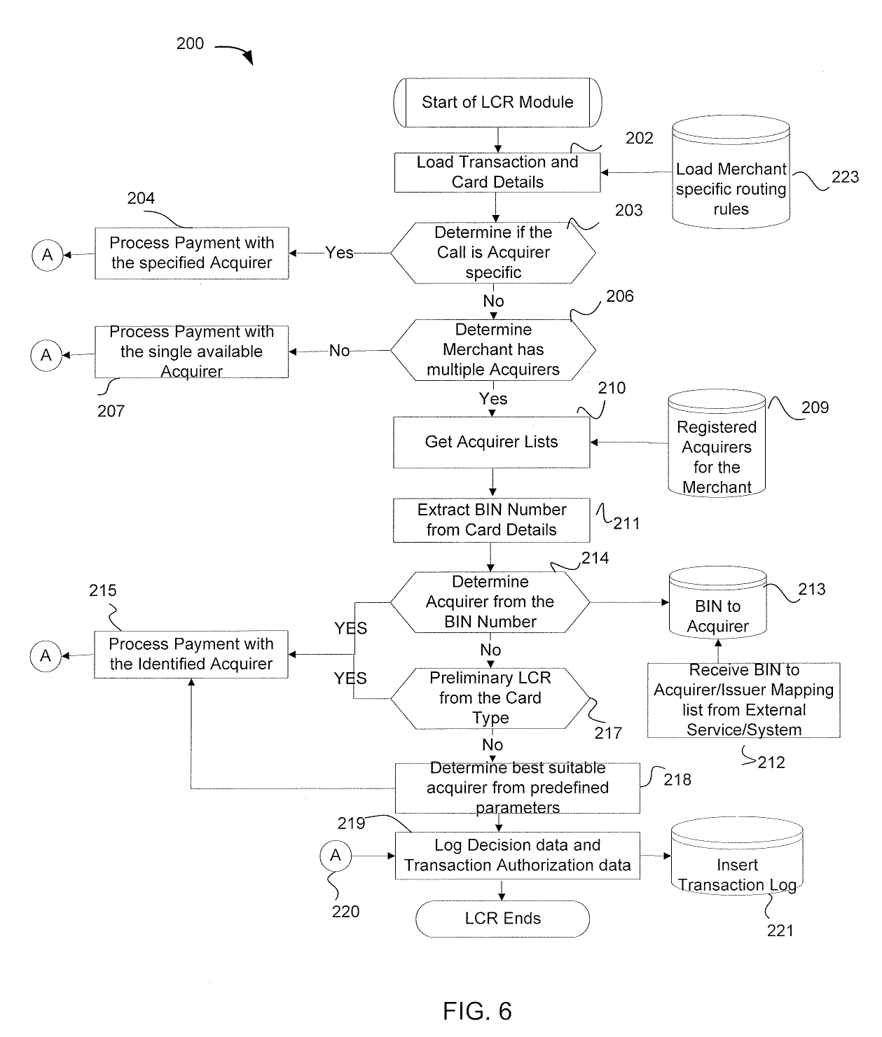

The least-cost routing application 122 utilizes the least-cost algorithm detailed in FIG. 6. The least-cost payment card acquiring bank is determined by the least-cost routing application 122 for each transaction. The least-cost payment card acquiring bank is the payment card acquiring bank that is, as determined according to the least-cost algorithm, most-likely to incur the least-cost for completing the payment transaction among all available payment card acquiring banks when the determination is made. The routing system 122 sends the transaction request to determined payment card acquiring bank for authorization. Once the transaction is received by the least-cost payment card acquiring bank, the transaction is processed either in-house as an on-us transaction, or routed to the payment card issuing bank to be processed as an off-us transaction. The transaction response is sent back to the provider payment gateway application 105 by the integrated payment card acquiring bank 114. The results will be used to effect an improvement to existing rules that govern the least-cost routing application. The present disclosure thereby ensures that every transaction is processed by the payment card acquiring bank offering most-likely the least cost for processing. Thus, processing the transaction utilizing the Least Cost Provider Payment Gateway results in lower payment processing charges. For example transaction using Citibank credit card will be directed to Citibank acquirer, while a transaction using HSBC credit card will be directed to HSBC acquirer to ensure lower cost transaction processing charges. In case of network issues preventing access to a particular payment card acquiring bank, the next available least cost payment card acquiring bank will be chosen for authorization and processing of payment transaction.

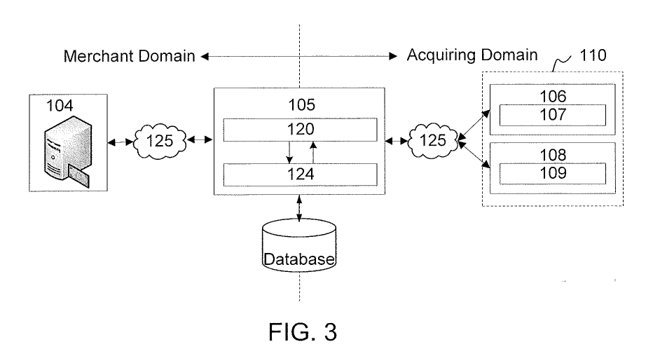

FIG. 3 is a diagrammatic representation of risk identification and risk management in processing payments in the ecommerce domain. The transaction originating from a merchant's ecommerce application 104 is sent to a provider payment gateway application 105 via a network 125. The transaction is routed to a payment card acquiring domain 110 by the provider payment gateway application 105 via a network 125. The provider payment gateway application 105 includes Transaction Processing application 120 and Settlement & Reconciliation application 124. The payment card acquiring banks 106 and 108 perform risk management checks using their internal risk management software applications 107 and 109 depicted in the diagram. Some payment card acquiring banks may also connect to Vendor Risk management solutions. These vendor solutions may be hosted externally or installed within 106/108. The merchant has no apparent control over the risk management checks as they are carried out entirely in the payment card acquiring domain. The transactions that are deemed fraudulent by the payment card acquirer's risk management system are blocked without any means of redress from the merchant who knows his business best. Therefore in the above method there is a possibility of genuine transactions being blocked which would result in lost revenue to the merchant. Typical example would be in Tourism countries, where travelers who do high value transactions might get their cards blocked by payment card Acquirers 106 and 108 based on their internal risk management software applications 107 and 109 even though these are genuine transactions. Settlement & Reconciliation software application 124 does the daily and monthly reconciliation between merchant E-commerce 104 and payment card Acquirers 106 and 108.

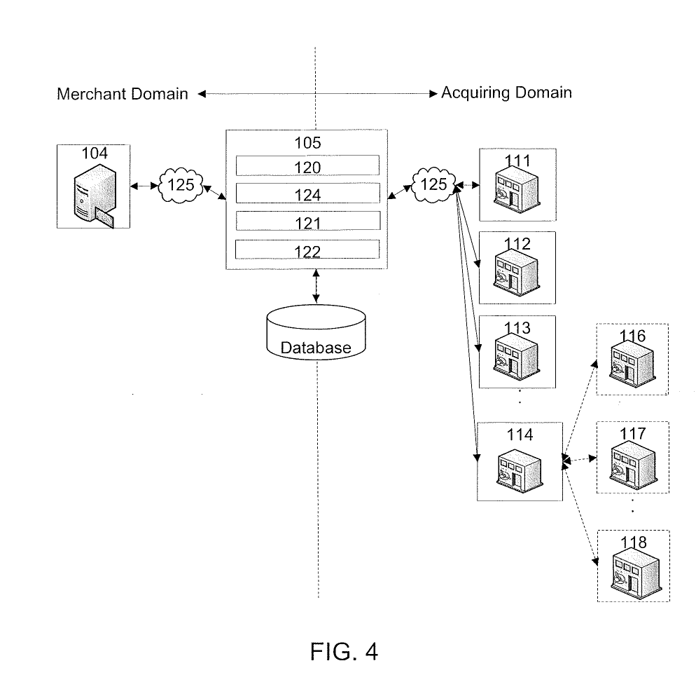

FIG. 4 is a diagrammatic representation of various functional blocks namely Transaction Processing application, Least Cost routing application, Risk Management application, and Settlement & Reconciliation application contained within the provider payment gateway application 105 according to an embodiment of the present disclosure. The transaction which originates from a merchant's ecommerce application 104 is routed to a provider payment gateway application 105. The provider payment gateway application 105, which is based on the present disclosure, has Transaction Processing application 120, Settlement & Reconciliation application 124, Least Cost Routing application 122 and an inbuilt risk management application 121. The Transaction processing application 120, Settlement & Reconciliation application 124 have been explained in the earlier sections of this document. The Risk Management application 121 determines the risk score of the payment transaction. The score is assigned to the payment transaction based on various checks and validations. The transaction that passes the risk management check is sent to the least-cost routing application in order to determine the payment card acquirer. The risk management application 121 is controlled by user definable parameters and provides more control to merchants to implement their Risk strategy. This provides additional protection against fraudulent transactions for merchants and minimizes financial risk. Unlike the methods according to FIG. 3, where the control of the risk management features lies in the acquirer domain, the methods according to FIG. 4 ensure that the controls are available with the merchant to control fraudulent transactions in addition to Risk management features contained within Acquirers 111, 112, 113 and 114. Network 125 is a secure network where payments data is passed using secure HTTPS protocol, in some embodiments.

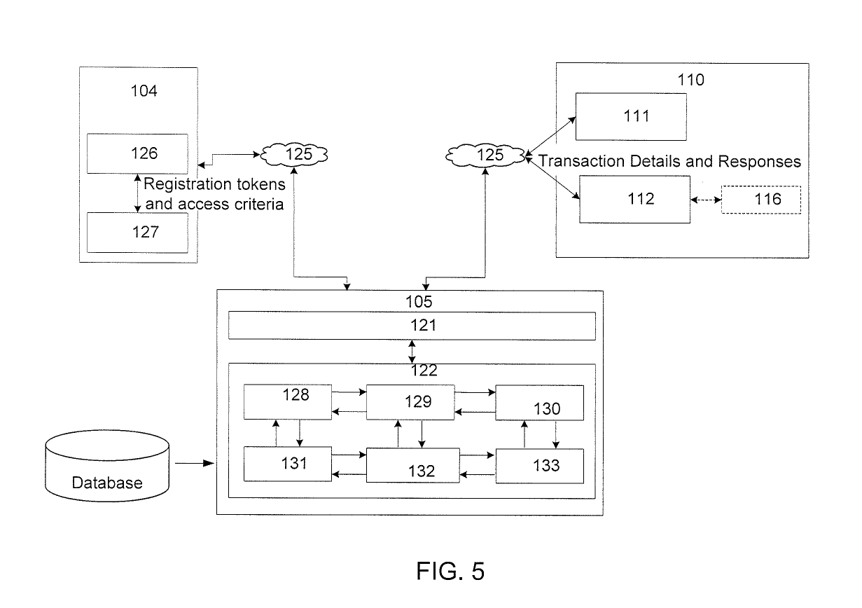

FIG. 5 is a diagrammatic representation of the various functional blocks of the least-cost routing software application 122 interacting with an overall provider payment gateway according to an embodiment of the present disclosure. Provider payment gateway application 105 receives order details 126 (along with Shipping Address) and payment details 127 (Card details, First Name, Billing Address, etc) from the merchant commerce system 104 through network 125 via secure HTTPS protocol. These details are received by provider payment gateway application 105 for authentication and payment processing. Once the transaction successfully passes a risk management check by risk management application 121, it proceeds to the least-cost routing application 122.

Least-cost routing application 122 has a transaction parser 128 to extract the payment card details from the incoming transaction. Decision agent application 129 determines the payment card acquirer offering the least cost for processing the payment transaction from all the payment card acquirers integrated with the provider payment gateway application based on rules defined within this application. Rules describe the operations, path to follow, exceptions and constraints that apply to payment transaction mainly around determination of the least cost payment card acquirer and risk management. Inputs from merchants result in reconfiguration of these rules. Routing agent 130 routes the payment transaction to the payment card acquirer identified by the decision agent application 129. Predictive adaptive analyzer 132 monitors and improves the transaction routing decisions made by the decision agent 129. Data loader 131 updates the decision agent 129 with the improvements made by the predictive adaptive analyzer 132 and helps refine the Rules Set within Decision Agent application 129. Data logger 133 ensures that all the transaction logs are stored in line with Payment Card Industry Data Security Standards (PCI DSS) compliance requirements for further reference. In some embodiments, the applications, rules sets, log databases have been built using Microsoft .Net framework and databases. These applications contain sets of instructions that are executable by the hardware processor. However, other platforms and programming languages can also be used to build these software applications. The Payment data is routed via secure Network 125 to payment card acquirer 111 or 112 contained in payment card Acquirer domain 110 based on payment card acquirer identified by decision agent application 129. If off-us payment transaction acquirer 112 is chosen then the payment transaction passes to payment card issuing Bank 116 for authentication of the payment data.

FIG. 6 is a flow chart of a method 200 for the provider payment gateway application to route payment transactions by determining the lowest cost for processing the payment transaction. Payment card acquirer-specific rules are identified from the database 223 and checked at a step 202. A check 203 is made to determine if the incoming transaction is acquirer specific. If the payment transaction is payment card acquirer-specific, the payment transaction is routed to the specified payment card acquirer at step 204. If the transaction is not payment card acquirer-specific, a check 206 is made to the payment transaction to determine if there are multiple payment card acquirers integrated for the respective merchant. If the payment transaction is for a merchant who has only a single integrated payment card acquirer, then the payment transaction is processed with single payment card acquirer 207. If there are multiple payment card acquirers for the merchant in registry 209, then a list of available payment card acquirers is retrieved for the particular payment transaction (step 210). The Bank Identification Number (BIN) details from the payment card number utilized for the particular payment transaction are extracted at step 211. The BIN number is matched from the database containing the BIN ranges of the payment cards issued by the integrated payment card acquirers at step 214. If a match is made then the payment transaction is routed to the payment card acquirer who has issued the payment card utilized in the payment transaction 215. If a match is not made in step 214, then a best possible payment card acquirer meeting the criterion of most-likely least cost payment card acquirer is selected based on pre-configured parameters at step 218.

For example, if customer uses Citibank credit card for payment at merchant registered with Citibank for acquiring, the transaction is initiated and a check 203 is done to determine if it is acquirer specific and the transaction flows to next step 206 to check if merchant has (i.e., being associated with) multiple acquirers. In this case, it is single acquirer relationship and therefore the transaction flows to step 207 where the payment gets processed via Citibank In the second scenario a customer uses Citibank credit card at merchant having multiple acquiring relationships—Citibank, HSBC, Royal Bank of Scotland. The transaction is initiated and a check 203 is done to determine if it is acquirer specific and the transaction flows to next step 206 to check if merchant has multiple acquirers. Transaction flows to next step 210 and list of acquirers is retrieved from database (209). In step 211, the BIN number is extracted from customer's card and a match is done to the Acquirer using this BIN number in step 213 and payment is processed with the identified Acquirer (in this case Citibank) in step 215.

The block 203 contains the logic of least-cost routing (LCR) algorithm, which determines whether the specific payment card acquirer is provided to proceed with the transaction. If the payment card acquirer details are provided, the payment process is completed with the specified payment card acquirer at step 204. Otherwise, the system will determine whether the current merchant has multiple payment card acquirers associated with it at step 206. If it is determined that the merchant only has a single payment card acquirer associated with it, then the payment process is completed utilizing that payment card acquirer's details 207. If it is determined that the merchant is associated with multiple payment card acquirers, then the registered payment card acquirers for the merchant are fetched from the database 209. The payment card acquirers associated with the current merchant are listed at step 210. After the identification of the payment card acquirer, the least-cost routing payment transaction as determined according to the least-cost routing algorithm is executed during the course of various steps. The extraction step 211 of a BIN Number from the payment card details provided by the customer is completed. The mapping step 212 of the extracted BIN number to the payment card acquirer or payment card issuer list from external service 213 is then executed. The payment card type, whether Visa, Master Card or another type, is determined at step 217. Based on BIN number mapping and payment card type identification, the specific payment card acquirer with most likely least cost service charge is identified for least-cost routing. The identified payment card acquirer is utilized to process the payment at step 215. The results of the decision software application are logged at step 219 along with the authorization details of the payment transaction routed to the least-cost acquirer (that is most likely to incur least cost among all available acquirers at the time the determination is made). The logged data is utilized by the predictive adaptive analyzer depicted at block 312 in FIG. 5.

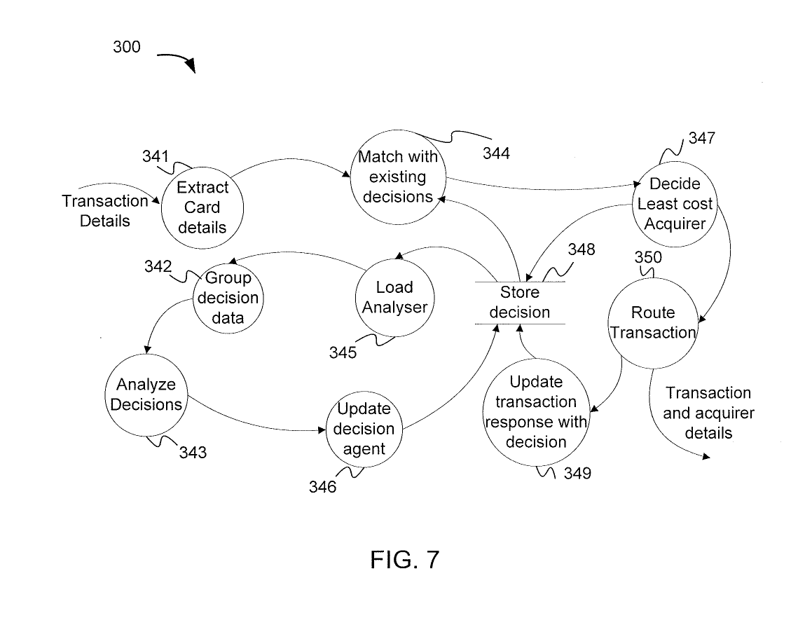

FIG. 7 is a graphical representation 300 of the working flows of the predictive adaptive analyzer 312. The least-cost payment card acquirer decisions for historical transactions are stored along with the authorization details within data store 348. When the decision identifying the least-cost payment card acquirer is made at step 347, the decision is communicated to payment transaction routing agent 350 to route the payment transaction to the decided least-cost payment card acquirer. The decision is also stored in the decision store 348 for further analysis. The payment transaction is routed to the determined least-cost payment card acquirer 350 and the authorization details for the payment transaction are stored within the data store 348.

Load analyzer 345 retrieves the archived payment transaction and decision data from the data store 348 and determines the rules that were utilized to arrive at the decision for identifying the least-cost payment card acquirer. Group decision agent 342 identifies and marks the rules that were effective in identifying the least-cost payment card acquirer. The decision data is correlated with the result of the payment transaction response received from the most likely least cost payment card acquirer. The group decision agent classifies the data collections based on predefined categories like success ratio for the payment transactions sent to the least-cost payment card acquirer. The ranking of the rules that were most effective in arriving at a successful least-cost payment card acquiring decision are identified at step 343. The identified decision is analyzed and updated within the data store at step 346. The updated rules to be utilized for future decision making to identify the least-cost payment card acquirers are updated within the data store 348 forming the adaptive component of the analyzer. The methods specified in the present disclosure as detailed above ensure that the least-cost decisions are refined when suitable.

For example, assuming that the Merchant has three payment card acquiring bank relationships—bank1, bank2 and bank3 and 100 transactions have been processed using the Least cost routing logic (bank1 for international transactions, bank2 for payment card not present and bank3 for payment card present) and stored in data store 348. Load analyzer 345 retrieves from data store 348 the routing logic for all these 100 transactions for analysis of the rules that determined the Least-cost payment card acquirer for each payment transaction. Step 343 evaluates these rules to identify the most effective rules and determines that payment transactions should go to bank1 for both international transactions and payment card not present, bank2 is only for On-Us transactions and bank3 is for payment card present transactions. This set of new rules is updated via step 346 and will be used for all future payment transactions to determine Least-cost routing.

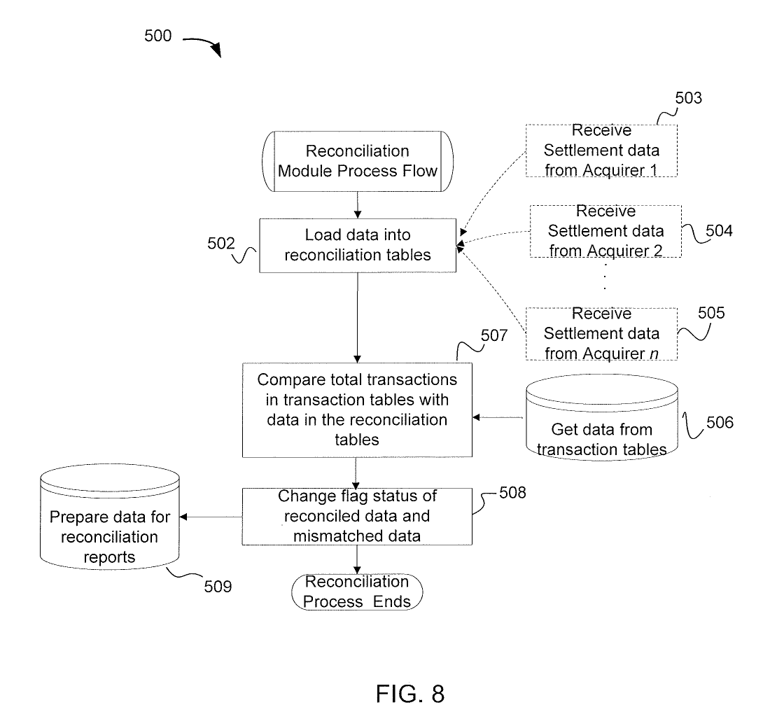

The reconciliation process of the present disclosure ensures that customer payment transactions processed by the provider payment gateway application through the determined least-cost payment card acquirer for the merchant ecommerce application, are accounted against the settlement data available with the payment card acquiring bank records. FIG. 8 details a reconciliation process 500 carried out in the current disclosure. The present system has a plurality of integrated payment card acquirers. The plurality of payment card acquirers provides a settlement file to the merchant at a specified time period (e.g., at blocks 503, 504, 505). The data received in steps 503, 504, 505 is loaded into the reconciliation data store 502 and compared against the payment transaction data for the respective merchant. Step 506 is used for retrieving data from Transaction table which contains payment transactions processing during that particular day. The comparison is made between the total payment transaction data fetched from the transaction tables and the data from the reconciliation tables at step 507. A flag status of the reconciled and mismatched data is changed according to the result of the comparison made at step 508. The data from the reconciliation is stored for future usage at step 509. The present disclosure provides a means to load the various data files belonging to the plurality of payment card acquirers into the system. The entire reconciliation process is handled within the provider payment gateway application through the gateway's user interface. The file formats and the various field specifications are configured using the gateway's user interface. The online configuration of the reconciliation process which is predominantly a back-end process is an improvement over the existing art.

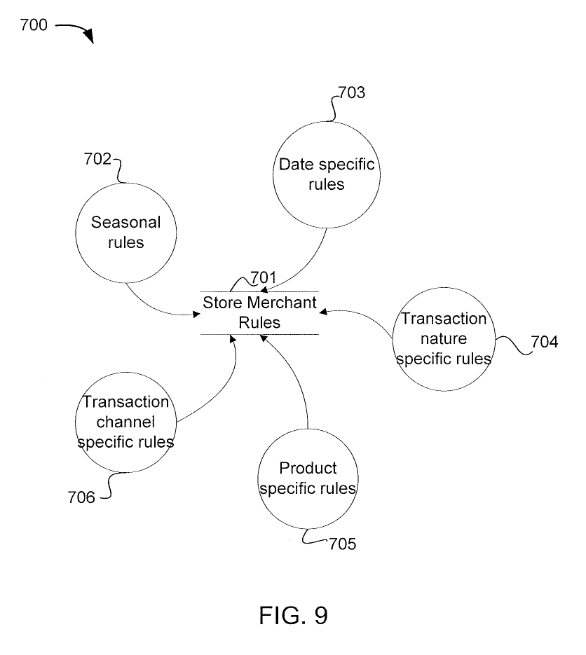

The present disclosure provides merchants with options to configure specific rules within the least-cost routing system. FIG. 9 is a graphical representation on how various rules for routing the transactions which originate from various input channels are specified within the least-cost routing data store. Graphical representation 700 depicts seasonal rules 702, rules pertaining to date 703, transaction nature specific rules 704, product-specific rules 705, and transaction channel specific rules 706, all of which are stored as store merchant rules 701.

Seasonal rules help Banks/merchants to define transaction rates for a specific holiday or festival season. Transaction nature rules are defined for various types of transactions like payment card present, payment card not present, recurring transactions, etc. Product-specific rules are defined to promote a specific product line as part of a marketing campaign or partnership in loyalty management program. Channel rules are created to take care of transactions originating from computers, mobile, IVR.

The present disclosure provides a least-cost routing software application to determine the most likely lowest processing charge for every transaction. The disclosure also provides a way to improve the least-cost routing mechanism from analyzing the result of payment transactions as highlighted above. The disclosure also provides risk mitigation and management features to merchants. The provider payment gateway application described in the present disclosure differentiates itself from other payment gateways at least by being merchant centric rather than being payment card acquirer centric.

The present disclosure provides a computer-implemented method executed by a provider payment gateway system to select the least-cost payment acquirer for each electronic payment made through a merchant electronic commerce system, or other channels like IVR, in-store, wherein a merchant has a choice to select a payment acquirer from a plurality of integrated payment acquirers; the method involves loading transaction and payment details of a payment instrument by a customer, retrieving a payment card acquirer list, determining a most likely least-cost acquirer utilizing a set of predetermined parameters where the merchant has multiple acquirers available.

The present disclosure provides a payment gateway system that has, inter alia, a processor and a non-transitory storage, wherein the storage is encoded with a set of instructions for causing the processor to function as a risk management software application configured to analyze a risk score for payment transactions between customers and merchants, wherein payment transactions below a predetermined threshold are sent to least-cost routing software application, the least-cost routing software application being configured to select a payment card acquirer from a plurality of integrated payment card acquirers for the payment transactions; and a reconciliation software application configured to dynamically set and modify file formats of the payment card acquirers involved in processing the payment transactions.

The present disclosure provides a computer-implemented method of routing payment transactions utilizing a merchant electronic commerce payment gateway, or other channels like IVR, in-store, wherein the method comprises loading a set of risk rules from a risk management software application, rejecting or halting the payment transaction if a risk threshold is exceeded utilizing the risk rules, loading a predetermined set of routing parameters from a least-cost routing software application if the risk threshold is not exceeded utilizing the risk rules, and determining a most likely least-cost payment card acquirer utilizing the predetermined set of routing parameters.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A computer-implemented method executed by a hardware provider payment gateway system to select a least-cost payment acquirer for an electronic payment to a merchant, the method comprising:
loading transaction and payment details of a payment instrument;
retrieving an acquirer list of one or more payment acquirers associated with the merchant and available to the provider payment gateway system; and
determining, by the provider payment gateway system, a least-cost acquirer among the one or more payment acquirers utilizing a set of predetermined parameters.

2. The computer-implemented method of claim 1, wherein determining the least-cost acquirer further comprises:
determining if a match is available between an issuing institution of the payment instrument and one of the one or more payment acquirers;
identifying the issuing institution as the least-cost acquirer if the match is available; and
determining the least-cost acquirer among the one or more payment acquirers if the match is not available.

3. The computer-implemented method of claim 2 further comprising:
determining if a preliminary least-cost routing decision can be made using a card type of the payment instrument;
processing the electronic payment according to the preliminary least-cost routing decision if it is determined that the preliminary least-cost routing decision can be made; and
proceeding to determining the least-cost acquirer utilizing the set of predetermined parameters if it is determined that the preliminary least-cost routing decision cannot be made.

4. The computer-implemented method in claim 1 further comprising logging the determination of the least-cost acquirer in order to compile a history of payment details.

5. The computer-implemented method in claim 4 further comprising:
analyzing the history of payment details; and
refining the set of least-cost routing parameters based on the analysis of the history of payment details.

6. The computer-implemented method of claim 1 further comprising:
determining if the transaction is acquirer specific;
processing payment with the specific acquirer if the transaction is acquirer specific; and
proceeding to determining the least-cost acquirer utilizing the set of predetermined parameters if the transaction is not acquirer specific.

7. The computer-implemented method of claim 1 further comprising:
determining if the merchant has multiple acquirers available;
processing payment with a single available acquirer if the merchant does not have multiple acquirers available; and
proceeding to determining the least-cost acquirer utilizing the set of predetermined parameters if the merchant has multiple acquirers available.

8. A payment gateway system for merchant electronic commerce, the system comprising a hardware processor and a non-transitory storage, wherein the storage is encoded with a set of instructions for causing the processor to execute:
a risk management software application to analyze a risk score for payment transactions between customers and merchants, wherein payment transactions below a predetermined threshold are sent to a least-cost routing software application;
the least-cost routing software application to select a payment acquirer from a plurality of integrated payment acquirers for the payment transactions; and
a reconciliation software application to dynamically set and modify file formats of the acquirers involved in processing the payment transactions for the plurality of integrated acquirers.

9. The payment gateway system of claim 8, wherein the least-cost routing software application is further configured to retrieve an acquirer list and select an acquirer utilizing a set of predetermined parameters.

10. The payment gateway system of claim 8, wherein the least-cost routing software application further comprises instructions for causing the processor to function as:
a transaction parser;
a decision agent configured to receive transaction data from the transaction parser and to send decision data to the transaction parser; and
a transaction routing agent configured to receive decision data from the decision agent.

11. The payment gateway system of claim 10, wherein the least-cost routing software application further comprises instructions for causing the processor to function as a data logger configured to receive routing information from the transaction routing agent and to send log results to the transaction routing agent.

12. The payment gateway system of claim 11, wherein the least-cost routing software application further comprises instructions for causing the processor to function as a predictive adaptive analyzer configured to receive log results from the data logger and to analyze the log results.

13. The payment gateway system of claim 12, wherein the least-cost routing software application further comprises instructions for causing the processor to function as a data loader configured to receive a predetermined set of rules from the predictive adaptive analyzer and configured to send data to and receive data from the transaction parser.

14. The payment gateway system of claim 8, wherein the payment gateway system is further configured to integrate additional acquirers dynamically within the system without interruption to ongoing processes.

15. A computer-implemented method executed by a hardware provider payment gateway system to select a least-cost payment acquirer for a payment transaction to a merchant, the method comprising:
loading a set of risk rules from a risk management software application;
halting the payment transaction if a risk threshold is exceeded utilizing the risk rules;
loading a predetermined set of routing parameters from a least-cost routing software application if the risk threshold is not exceeded utilizing the risk rules; and
determining a least-cost acquirer utilizing the predetermined set of routing parameters.

16. The computer-implemented method, wherein determining a least-cost acquirer utilizes at least one of seasonal rules, date-specific rules, transaction-nature specific rules, transaction channel-specific rules, or product-specific rules.
